(19) United States
(12) Patent Application Publication
(10) Pub. No.: US 2020/0111146 A1
(43) Pub. Date: Apr. 9, 2020

(54) INFORMATION DETERMINING METHOD AND APPARATUS

(71) Applicant: BEIJING XIAODU INFORMATION TECHNOLOGY CO., LTD., Beijing (CN)

(72) Inventor: Nengneng JIANG, BEIJING (CN)

(21) Appl. No.: 16/710,115

(22) Filed: Dec. 11, 2019

Related U.S. Application Data
(63) Continuation of application No. PCT/CN2017/118776, filed on Dec. 26, 2017.

(30) Foreign Application Priority Data
Jun. 12, 2017 (CN) 201710440051.X

(51) Int. Cl. G06Q 30/06

(52) U.S. Cl. CPC G06Q 30/0629; G06K 9/6215

(57) ABSTRACT

An information determining method and apparatus, an electronic device, and a computer storage medium are disclosed. The method includes: determining a product similarity between a product of a first product provider and a product of a second product provider; and determining, based on the product similarity, whether the first product provider is the same as the second product provider. This method can efficiently and accurately detect duplication providers among multiple product providers.

### CROSS-REFERENCE To RELATED APPLICATION

This application is a continuation application of International Patent Application No. PCT/CN2017/118776, filed on Dec. 26, 2017, which is based on and claims priority to the Chinese Patent Application No. 201710440051.X, filed on Jun. 12, 2017 and entitled “INFORMATION DETERMINING METHOD AND APPARATUS.” The above-referenced applications are incorporated herein by reference in their entirety.

### TECHNICAL FIELD

This disclosure pertains to the field of Internet technologies, and more specifically, to an information determining method and apparatus, an electronic device, and a computer storage medium.

### BACKGROUND

With the development of internet and electronic technologies, online shopping, for its convenience and efficiency, is becoming increasingly pervasive in people's daily life.

In reality, a product provider may sell its products on more than one online transaction systems. Therefore, to effectively regulate online transactions and provide a satisfying transaction experience to a product provider, in some scenarios, it is desirable to determine whether the same product provider exists in multiple online transaction systems.

### SUMMARY

To determine whether the same product provider exists in different online transaction systems, duplication determination needs to be performed for the product providers. This invention provides an information determining method and apparatus to effectively perform duplication determination for product providers, thereby improving accuracy of duplication determination.

To resolve the foregoing technical problem, a first aspect of this disclosure is directed to an information determining method. The method may include: determining a product similarity between a first product provider and a second product provider; and determining whether the first product provider is the same as the second product provider based on the product similarity. Determining a product similarity between a first product provider and a second product provider may include: obtaining at least one matching pair comprising a product of the first product provider and a product of the second product provider, wherein a price difference between the products meets a price deviation requirement; and determining the product similarity between the products of the at least one matching pair.

In some embodiments, the aforementioned method may further include: before determining the product similarity, determining the second product provider matching the first product provider based on a provider name of the first product provider.

In some embodiments, in the aforementioned method, determining the second product provider may include: obtaining backbone information from the provider name of the first product provider; and determining the second product provider. A provider name of the second product provider may include the backbone information.

In some embodiments, in the aforementioned method, determining whether the first product provider is the same as the second product provider may include: determining whether the first product provider is the same as the second product provider based on the product similarity between the products of the at least one matching pair.

In some embodiments, in the aforementioned method, determining the product similarity between the products of the at least one matching pair may include: determining a string similarity between product names of two products in each of the at least one matching pair; and designating the string similarity as the product similarity of each of the at least one matching pair.

In some embodiments, in the aforementioned method, determining the product similarity between the products of the at least one matching pair may include: determining an image similarity based on picture information of the products in each of the at least one matching pair; and designating the image similarity as the product similarity of each of the at least one matching pair.

In some embodiments, in the aforementioned method, determining whether the first product provider is the same as the second product provider may include: for each of products of the first product provider and each of products of the second product provider, determining, among product similarities of matching pairs including the product, a maximum product similarity as a to-be-processed similarity of the product; determining a comprehensive product similarity between the first product provider and the second product provider, wherein the comprehensive product similarity is a ratio of a quantity of the products whose to-be-processed similarities are greater than a specified threshold to a sum of a quantity of the products of the first product provider and a quantity of the products of the second product provider; and determining whether the first product provider is the same as the second product provider based on the comprehensive product similarity.

In some embodiments, the aforementioned method may further include: determining, based on at least one attribute factor of the first product provider and the second product provider, at least one attribute similarity between the first product provider and the second product provider. Determining whether the first product provider is the same as the second product provider may include: determining whether the first product provider is the same as the second product provider based on the comprehensive product similarity and the at least one attribute similarity.

In some embodiments, in the aforementioned method, determining whether the first product provider is the same as the second product provider may include: determining a total similarity by performing weighted summation of the comprehensive product similarity and the at least one attribute similarity; and determining whether the first product provider is the same as the second product provider based on the total similarity.

In some embodiments, in the aforementioned method, the at least one attribute factor may include a provider name, a service address, a communication mode, and geographic coordinates.

A second aspect of this disclosure is directed to an information determining apparatus. The apparatus may include a first calculation module and a judging module. The first calculation module may be configured to determine a product similarity between a first product provider and a second product provider. The judging module may be configured to determine whether the first product provider is the same as the second product provider based on the product similarity. The first calculation module may include a matching unit and a first calculation unit. The matching unit may be configured to obtain at least one matching pair comprising a product of the first product provider and a product of the second product provider, wherein a price difference between the products meets a price deviation requirement. The first calculation unit may be configured to determine the product similarity between the products of the at least one matching pair.

In some embodiments, the aforementioned apparatus may further include a determining module, configured to determine, based on a provider name of the first product provider, the second product provider matching the first product provider.

In some embodiments, in the aforementioned apparatus, the determining module may include a selection unit and a determining unit. The selection unit may be configured to obtain backbone information from the provider name of the first product provider. The determining unit may be configured to determine the second product provider. A provider name of the second product provider may include the backbone information.

In some embodiments, in the aforementioned apparatus, the judging module may be configured to determine whether the first product provider is the same as the second product provider based on the product similarity between the products of the at least one matching pair.

In some embodiments, in the aforementioned apparatus, the first calculation unit may be configured to determine a string similarity between product names of the products in each of the at least one matching pair; and designate the string similarity as the product similarity of each of the at least one matching pair.

In some embodiments, in the aforementioned apparatus, the first calculation unit may be configured to determine an image similarity based on picture information of the products in each of the at least one matching pair; and designate the image similarity as the product similarity of each of the at least one matching pair.

In some embodiments, in the aforementioned apparatus, the judging module may include a second calculation unit and a judging unit. The second calculating unit may be configured to: for each of products of the first product provider and each of products of the second product provider, determine, among product similarities of matching pairs including the product, a maximum product similarity as a to-be-processed similarity of the product; and determine a comprehensive product similarity between the first product provider and the second product provider. The comprehensive product similarity may be a ratio of a quantity of products whose to-be-processed similarities are greater than a specified threshold to a sum of a quantity of the products of the first product provider and a quantity of the products of the second product provider. The judging unit may be configured to determine whether the first product provider is the same as the second product provider based on the comprehensive product similarity.

In some embodiments, the aforementioned apparatus may further include a second calculation module. The second calculation module may be configured to determine at least one attribute similarity between the first product provider and the second product provider based on at least one attribute factor of the first product provider and the second product provider. The judging unit may be configured to determine whether the first product provider is the same as the second product provider based on the comprehensive product similarity and the at least one attribute similarity.

In some embodiments, in the aforementioned apparatus, the judging unit may be configured to determine a total similarity by performing weighted summation of the comprehensive product similarity and the at least one attribute similarity; and determine whether the first product provider is the same as the second product provider based on the total similarity.

In some embodiments, in the aforementioned apparatus, the at least one attribute factor may include a provider name, a service address, a communication mode, and geographic coordinates.

A third aspect of this invention is directed to an electronic device comprising one or more processors and one or more memories. The one or more memories may store one or more computer instructions executable by the one or more processors. Upon being executed by the one or more processors, the one or more computer instructions may cause the one or more processors to perform the information determining method in any of the aforementioned embodiments.

A fourth aspect of this invention is directed to a computer readable storage medium storing a computer program. Upon being executed by a computer, the computer program may cause the computer to perform the information determining method in any of the aforementioned embodiments.

Compared with the prior art, this invention can obtain the following technical effects.

For the first product provider and the second product provider, the product similarity between the product of the first product provider and the product of the second product provider may first be determined, and then, based on the product similarity, whether the first product provider is the same as the second product provider may be determined. Because of high stability of the products, duplication determination can be effectively performed, thereby improving the accuracy of duplication determination.

### BRIEF DESCRIPTION OF THE DRAWINGS

The accompanying drawings described herein are intended to provide a further understanding of this disclosure, and constitute a part of this disclosure. The illustrative embodiments of this disclosure and descriptions thereof are intended to describe this disclosure, and do not constitute limitations on this disclosure.

FIG. 1 is a flowchart illustrating an information determining method according to an embodiment of this disclosure.

FIG. 2 is a flowchart illustrating an information determining method according to another embodiment of this disclosure.

FIG. 3 is a schematic structural diagram of an information determining apparatus according to an embodiment of this disclosure.

FIG. 4 is a schematic structural diagram of an electronic device according to an embodiment of this disclosure.

### DETAIL DESCRIPTION OF THE EMBODIMENTS

The implementations of this disclosure are described below in detail with reference to accompanying drawings and embodiments to provide a full understanding of, and implement an implementation process of, using technical means in this disclosure to resolve technical problems and achieve technical effects.

Some procedures described in the specification, claims, and accompanying drawings of this disclosure include a plurality of operations that occur in a specific order. However, it should be clearly understood that these operations may not be performed according to an occurrence order of the operations in this specification or may be performed in parallel. Operation sequence numbers such as 101 and 102 are merely intended to distinguish between different operations, and the sequence numbers do not represent any execution order. In addition, these procedures may include more or fewer operations, and these operations may be performed in order or performed in parallel. It should be noted that “first”, “second”, and the like described in this specification are intended to distinguish between different messages, devices, modules, and the like, and do not represent an order or indicate that “first” and “second” are different types.

The technical solutions in the embodiments of this disclosure are mainly applied to an online transaction scenario, for example, an Online-To-Offline (O2O) application scenario. In an online transaction scenario, a product provider may provide products, and a user may purchase, by using an online transaction system, the products provided by the product provider. For example, the products may be various commodities. In an O2O-based take-out order application, the product provider may be an offline merchant who provides products, and the products may be take-out meals.

In actual application, because there is a need to determine whether the same product provider exists on different online transaction systems, duplication determination may need to be performed for the product providers. In the prior art, duplication determination may usually be performed based on a provider name of a product provider. Two product providers having the same provider name may be determined to be same. However, this determination method has a relatively low accuracy as a product provider may use different provider names in different systems. For example, “Native Beijing Deji Barbecue” and “Deji Barbecue in Shangdi” are the same product provider, but they may be determined as different product providers if determined by provider name only.

To perform effective duplication determination, stable or slightly changed factors need to be used to determine whether two product providers are the same, and products provided by the same product provider usually do not change too much.

Therefore, a determination on a product provider can be implemented through a determination on a product of the product provider. This is the basic principle the technical solutions of this disclosure are based on. In the embodiments of this disclosure, for any two product providers (e.g., a first product provider and a second product provider), a product similarity between a product of the first product provider and a product of the second product provider is first determined. Then, based on the product similarity, whether the first product provider is the same as the second product provider may be determined. A higher product similarity may indicate a higher probability that the first product provider and the second product provider are the same product provider. Because of high stability of the products, duplication determination can be effectively performed, thereby improving the accuracy of duplication determination.

The following clearly and completely describes the technical solutions in the embodiments of this disclosure with reference to the accompanying drawings.

Apparently, the described embodiments are merely some but not all of the embodiments of this disclosure. All other embodiments obtained by persons skilled in the art based on the embodiments of this disclosure without creative efforts shall fall within the protection scope of this disclosure.

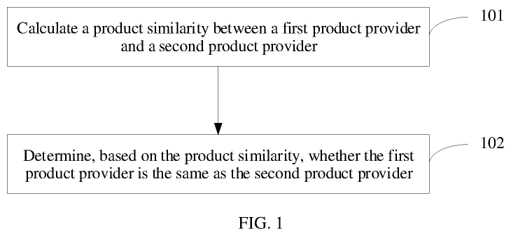

FIG. 1 is a flowchart illustrating an information determining method according to an embodiment of this disclosure. The method may include the following steps 101 to 102.

In step 101, a product similarity between a first product provider and a second product provider may be determined.

In step 102, based on the product similarity, whether the first product provider is the same as the second product provider may be determined.

The first product provider and the second product provider may be any two product providers. In this application, these two product providers are so named solely for the purpose of ease of description. Therefore, the terms “first” and “second” do not indicate or imply any special relationship, such as a sequential relationship or a progressive relationship, between these two product providers.

Both the first product provider and the second product provider may provide a plurality of products. A product similarity between each product of the first product provider and each product of the second product provider may be determined.

In addition, to improve processing efficiency, products may first be pre-screened so that similar products may be identified.

In this application, a product is referred to a commodity offered for sale, thus has a sale price associated with it.

In some embodiments, a product similarity between a first product provider and a second product provider may be determined through the following steps.

First, at least one matching pair that includes a product of the first product provider and a product of the second product provider may be determined. The product of the first product provider may be any product of the first product provider, the product of the second product provider may be any product of the second product provider. A price difference between these two products may meet a price deviation requirement. Second, a product similarity between the products of the at least one matching pair may be determined.

In the aforementioned steps, whether the first product provider is the same as the second product provider is determined based on the product similarity of the products of at least one matching pair. One matching pair may include one product of the first product provider and one product of the second product provider. One product may be included in more than one matching pair.

In one example, the price deviation requirement may be that a price difference being less than a preset threshold. In one example, a matching pair may include two products that have a price difference less than 5 yuan. In actual application, a second product of the second product provider may be selected based on a sale price of a first product of the first product provider, wherein a price difference between the second product and the first product meets the price deviation requirement. Then the first product and the second product may form a matching pair. The first product may be any product of the first product provider, and the second product may be any product of the second product provider.

After the product similarity is determined, whether the first product provider is the same as the second product provider may be determined based on the product similarity. For example, when the product similarity is greater than a preset similarity threshold, the first product provider and the second product provider may be determined to be the same. In another example, a plurality of product similarities between different products may be determined. In that case, the first product provider and the second product provider may be determined to be the same when a quantity of product similarities that are greater than the preset similarity threshold is greater than a preset quantity. Certainly, the determination may be performed through other suitable methods. This invention will be described in greater details through the following embodiments.

In the foregoing embodiments, whether the first product provider is the same as the second product provider may be determined based on the product similarity.

Because of higher stability of the products, duplication determination can be effectively performed, thereby improving the accuracy of duplication determination.

To further improve processing efficiency, a product provider may be pre-screened. Therefore, in some embodiments, before the product similarity between the first product provider and the second product provider is determined, the method may further include: determining the second product provider matching the first product provider based on a provider name of the first product provider.

More specifically, a product provider may be pre-screened based on a provider name Thus, a product similarity does not need to be computed between a product provider and all other product providers, thereby reducing computational complexity and improving processing efficiency.

The first product provider and the second product provider whose provider names match each other may be determined through several possible implementations.

In one example, the first product provider may be determined to match the second product provider if a preset quantities of strings in the provider names are matched.

A product provider may have several provider names Therefore, to improve matching accuracy, the preset quantity of strings may be backbone information in the provider name The backbone information is important identification information of a product provider. Therefore even though a product provider may have several provider names, these provider names may all include the backbone information.

In some embodiments, to determine the second product provider matching the first product provider based on a provider name of the first product provider, the method may include: obtaining backbone information from the provider name of the first product provider; and determining the second product provider. A provider name of the second product provider may include the backbone information.

A provider name provided by a product provider usually follows a specific naming rule, and usually includes a plurality of elements. Therefore, a structure expression may be preset, and the backbone information may be obtained from the provider name of the first product provider based on the structure expression.

When obtaining the backbone information, segmented word analysis may be first performed on the provider name to determine each piece of segmented word information in the provider name. Then, based on the structure expression, the segmented word belonging to the backbone information may be determined.

For ease of understanding, in an actual application, a structure expression of a provider name may be described as follows:

name=(Province)*(City)*(County)*(Stem)(Type)(Appendix)*

As shown above, the structure expression may include several elements, and a provider name may include one or more of these elements. Certainly, an arrangement order of the one or more elements included in a provider name is not limited to the order present in the foregoing structure expression. Details of these elements are described below.

“Province” is the province information in a provider name. For example, for a provider name of “Xinjiang Mehmet Roast Mutton”, “Xinjiang” is the province information.

“City” is the city information in a provider name For example, for a provider name of “Harbin Xu's Clinic”, “Harbin” is the city information.

“County” is similar to “Province” and “City”, and is the county-level administrative information in a provider name. A provider name may include one or more of “Province”, “City”, and “County”, and certainly may include none of these elements.

“Stem” is backbone information in a provider name. For example, for a provider name of “Beijing Yijia Cake Store”, “Yijia” is the backbone information.

“Type” is an industry characteristic in a provider name. For example, “Cake Store” in “Beijing Yijia Cake Store” is the industry characteristic.

“Appendix” is branch store information in a provider name For example,

“Shangdi” in “Beijing YiJia Cake Store (Shangdi)” is the branch store information.

A provider name may be segmented through segmented word analysis. For example, a provider name of “Beijing Yijia Cake Store” may be segmented into segmented words of “Beijing”, “Yijia”, and “Cake Store”. Based on the foregoing structure expression, the segmented word of “Yijia” is the backbone information.

A product similarity between two products may be determined based on product names A string similarity between product names of two products may be used as a product similarity between the two products.

In some embodiments, to determine the product similarity between the products of the at least one matching pair, a string similarity between product names of the products in each of the at least one matching pair may first be determined. Then the string similarity may be designated as the product similarity of each of the at least one matching pair.

A product name of a product is usually relatively short and may not need to be further segmented. A product name may include redundant information such as “+” and content included in parenthesis. Therefore, the redundant information may first be deleted from product names of two products, and remaining strings may be determined for similarity.

The string similarity may be determined based on a string editing distance. The string editing distance is a minimum quantity of edit operations required for converting one provider name into another provider name The editing operation may include replacing one character with another character, inserting a character, and deleting a character. Generally, a smaller editing distance indicates a higher string similarity between two provider names.

A string similarity between product names of two products may be determined according to a string similarity calculation formula of:

$$simi = \frac{len ( s 1 ) + len ( s 2 ) - d}{len ( s 1 ) + len ( s 2 )} ,$$

where simi is the string similarity, s1 and s2 are respectively the provider names of the two products, len( ) represents a string length of a provider name, and d is a string editing distance between the two provider names.

Additionally, an image similarity may be determined based on picture information of two products, and the image similarity may be designated as the product similarity between the two products.

In actual application, a product may be offered for sale, and may be a commodity, a dish, or the like. Therefore, a product generally may have picture information representing the product. A picture recognition technology may be used to determine whether two products are similar.

In some embodiments, to determine a product similarity between the products of the at least one matching pair, an image similarity may first be determined based on picture information of two products in each of the at least one matching pair. Then the image similarity may be designated as the product similarity of each of the at least one matching pair.

In the foregoing descriptions, the first product provider and the second product provider may correspond to at least one matching pair. In some embodiments, determining whether the first product provider is the same as the second product provider based on the product similarity of the at least one matching pair may include the following steps.

First, for each of products of the first product provider and each of products of the second product provider, a maximum product similarity may be determined from product similarities of matching pairs including the product. The maximum product similarity may be determined as a to-be-processed similarity of the product. Then a comprehensive product similarity between the first product provider and the second product provider may be determined based on a quantity of the products whose to-be-processed similarities are greater than a specified threshold, a quantity of the products of the first product provider, and a quantity of the products of the second product provider. Based on the comprehensive product similarity, whether the first product provider is the same as the second product provider may be determined.

More specifically, it may be assumed that the first product provider includes M products, and the second product provider includes N products. Because any one of the M+N products may belong to one or more matching pairs, a maximum product similarity may be selected from product similarities of matching pairs that include the product as a to-be-processed similarity of the product. If a product does not belong to any matching pair, the to-be-processed similarity of the product may be set to a minimum value (e.g., 0).

A quantity of the products whose to-be-processed similarities are greater than the specified threshold may be determined based on a value of the to-be-processed similarity.

More specifically, the comprehensive product similarity may be determined according to the formula of:

$$Z = \frac{x}{M + N} ,$$

where Z is the comprehensive product similarity, M is the quantity of the products of the first product provider, N is the quantity of the products of the second product provider, and X is the quantity of the products whose to-be-processed similarities are greater than the specified threshold.

Duplication determination may be performed on multiple dimensions to improve the accuracy.

Optionally, at least one attribute similarity between the first product provider and the second product provider may be determined based on at least one attribute factor of the first product provider and the second product provider.

Therefore, based on the comprehensive product similarity and the at least one attribute similarity, whether the first product provider is the same as the second product provider may be determined.

The at least one attribute factor may include, but not be limited to, a provider name, a service address, a communication mode, and geographic coordinates.

Based on an attribute similarity, whether attribute factors of two product providers are similar may be determined.

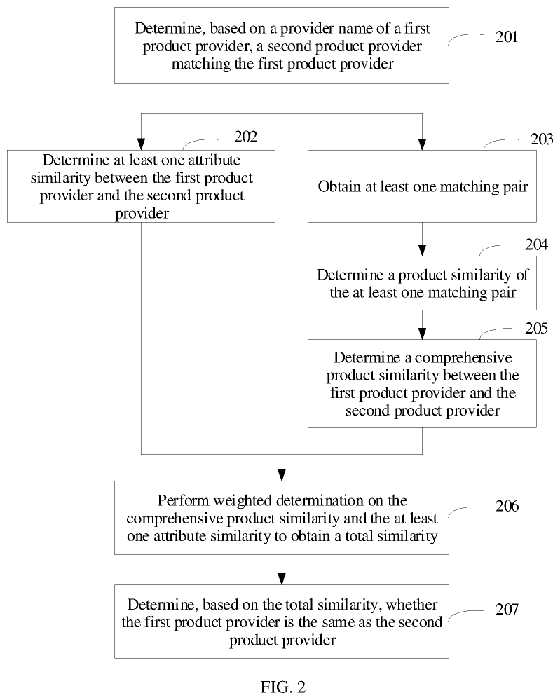

FIG. 2 is a flowchart illustrating an information determining method according to another embodiment of this disclosure. The method may include the following steps 201 to 207.

In step 201, a second product provider matching the first product provider may be determined based on a provider name of a first product provider.

Optionally, backbone information may be obtained from the provider name of the first product provider to determine the second product provider whose provider name includes the backbone information.

The first product provider may be a to-be-determined product provider. A full text retrieval technology may be used to retrieve all product providers whose provider names include the backbone information, and the second product provider may be any one of these product providers. For example, the full text retrieval technology may be Sphinx.

In step 202, at least one attribute similarity between the first product provider and the second product provider may be determined based on at least one attribute factor of the first product provider and the second product provider.

The at least one attribute factor may include, but not be limited to, a provider name, a service address, a communication mode, and geographic coordinates. The at least one attribute factor may represent a main feature of a product provider, and the main feature may also be used to recognize the product provider. Optionally, attribute similarities between a plurality of attribute factors may be determined by using the plurality of attribute factors. Then, based on the attribute similarities between the plurality of attribute factors, whether the first product provider is the same as the second product provider may be determined, thereby improving the accuracy of duplication determination.

An attribute similarity may be determined based on whether attribute factors are the same or similar.

Determination of an attribute similarity is explained and described in greater details below by using, respectively, a provider name, a service address, a communication mode, and geographic coordinates as an example.

Provider name:

The backbone information may be obtained from the provider names of the first product provider and the second product provider, and whether the two pieces of backbone information are the same may be determined. If the two pieces of backbone information are the same, an attribute similarity between the provider names may be set to a first similarity. If the two pieces of backbone information are different, an attribute similarity between the provider names may be set to a second similarity. The first similarity may be greater than the second similarity. Relevant part in the foregoing descriptions may be referred to for details of obtaining the backbone information. The second similarity may be 0.

Certainly, other determination methods, such as determining whether two provider names are the same, determining whether the two provider names include at least a first quantity of same consecutive strings, or determining whether the two provider names include at least a second quantity of same segmented word information, may be used. Correspondingly, if the two provider names are the same, or the two provider names include at least the first quantity of same consecutive strings, or the two provider names include at least the second quantity of same segmented word information, an attribute similarity may be set to a first similarity. Otherwise, an attribute similarity may be set to a second similarity. The segmented word information may be obtained by segmenting the provider name.

Service address:

The service address is an offline store address provided by a product provider, and usually may include a province, a city, a district, a street, a house number, and the like.

Therefore, it may be determined that whether service addresses of two product providers are the same, or whether the service addresses include at least a third quantity of same consecutive strings, or whether the service addresses include at least a fourth quantity of same segmented word information. If the service addresses of the two product providers are the same, or the service addresses include at least the third quantity of same consecutive strings, or the service addresses include at least the fourth quantity of same segmented word information, an attribute similarity may be set to a third similarity. Otherwise, an attribute similarity may be set to a fourth similarity. The third similarity may be greater than the fourth similarity, and the fourth similarity may be 0.

Communication mode:

The communication mode is usually a communication number.

Therefore, it may be determined whether communication numbers of two product providers are the same or whether the communication numbers include at least a third quantity of same consecutive strings. If the communication numbers of the two product providers are the same or the communication numbers include at least the third quantity of same consecutive strings, an attribute similarity may be set to a fifth similarity. Otherwise, an attribute similarity may be set to a sixth similarity. The fifth similarity may be greater than the sixth similarity, and the sixth similarity may be 0.

Geographic coordinates:

In an O2O application, each product provider may be an offline merchant. The geographic coordinates may be longitude and latitude coordinates obtained through

GPS positioning, or obtained based on a service address provided by the product provider.

Therefore, a corresponding attribute similarity may be set based on a position distance between the geographic coordinates of two product providers. For example, if the position distance is greater than a first distance, the attribute similarity may be set to a value a. If the position distance is greater than a second distance and less than a first distance, the attribute similarity may be set to a value b. If the position distance is less than a second distance, the attribute similarity may be set to a value c. A shorter distance may indicate a higher attribute similarity.

It should be noted that the foregoing descriptions are merely examples for describing a possible method of determining the attribute similarity, and this disclosure is not limited herein.

In step 203, at least one matching pair comprising a product of the first product provider and a product of the second product provider may be determined. A price difference between the product may meet a price deviation requirement.

In step 204, a product similarity between the products of the at least one matching pair may be determined.

A string similarity between product names of two products in each of the at least one matching pair may be determined, and the string similarity may be designated as the product similarity of the at least one matching pair.

An image similarity may be determined based on picture information of two products in each of the at least one matching pair, and the image similarity may be designated as the product similarity of the at least one matching pair.

In step 205, a comprehensive product similarity between the first product provider and the second product provider may be determined based on a quantity of matching pairs, a quantity of products of the first product provider, a quantity of products of the second product provider, and the product similarity of each matching pair.

In step 206, weighted determination may be performed on the comprehensive product similarity and the at least one attribute similarity to obtain a total similarity.

The weighted determination may be weighted summation or weighted averaging.

A weight coefficient of the comprehensive product similarity and a weight coefficient of each attribute similarity may be set according to an actual situation and a requirement for precision of duplication determination.

Alternatively, in an actual application scenario, if products have a relatively high similarity in one or more of attribute factors, a weight coefficient of a factor in a relatively high similarity may be increased, while a weight coefficient of a factor in a relatively low similarity may be decreased.

For example, when similarities between provider names, communication modes, and products of two product providers are relatively high, and similarities between service addresses and geographic coordinates are relatively low, the two product providers may be in a chain operation. Therefore, weight coefficients of the service address and geographic coordinates may be appropriately increased, and weight coefficients of other factors may be decreased.

In step 207, whether the first product provider is the same as the second product provider may be determined based on the total similarity.

For example, if the total similarity is greater than a total determining threshold, it may be determined that the first product provider is the same as the second product provider.

In this embodiment, duplication determination is performed from a plurality of dimensions and based on at least one attribute factor. Therefore, reliability of the determination may be improved, thereby improving the accuracy and efficiency of duplication determination.

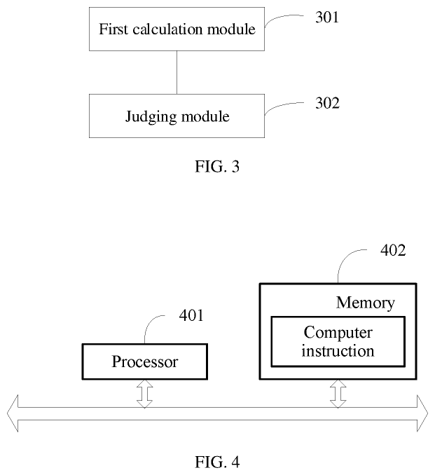

FIG. 3 is a schematic structural diagram of an information determining apparatus according to an embodiment of this disclosure. The apparatus may include a first calculation module 301 and a judging module 302.

The first calculation module 301 may be configured to calculate a product similarity between a first product provider and a second product provider. The judging module 302 may be configured to determine, based on the product similarity, whether the first product provider is the same as the second product provider.

In this embodiment, based on the product similarity, whether the first product provider is the same as the second product provider may be determined. Because of higher stability of the products, duplication determination can be effectively performed, thereby improving the accuracy of duplication determination.

To further improve processing efficiency, a product provider may be pre-screened. Therefore, in some embodiments, the apparatus may further include: a determining module configured to determine, based on a provider name of the first product provider, the second product provider matching the first product provider.

The determining module may include a selection unit and a determining unit.

The selection unit may be configured to obtain backbone information from the provider name of the first product provider. The determining unit may be configured to determine the second product provider. A provider name of the second product provider may include the backbone information.

Both the first product provider and the second product provider may provide a plurality of products. Optionally, a product similarity between each product of the first product provider and each product of the second product provider may be determined.

Additionally, to improve processing efficiency, products may be pre-screened to determine similar products. Therefore, in some embodiments, the first calculation module may include a matching unit and a first calculation unit. The matching unit may be configured to determine at least one matching pair comprising a product of the first product provider and a product of the second product provider. A price difference between the products may meet a price deviation requirement. The first calculation unit may be configured to determine a product similarity between the products of the at least one matching pair.

In this case, the judging module may be configured to determine, based on the product similarity of the at least one matching pair, whether the first product provider is the same as the second product provider.

In a possible implementation, the first calculation unit may be configured to: determine a string similarity between product names of two products in each of the at least one matching pair, and designate the string similarity as the product similarity of the at least one matching pair.

In another possible implementation, the first calculation unit may be configured to: determine an image similarity based on picture information of two products in each of the at least one matching pair, and designate the image similarity as the product similarity of the at least one matching pair.

In some embodiments, the judging module may include a second calculation unit and a judging unit. The second calculation unit may be configured to: for each of products of the first product provider and each of products of the second product provider, determine, among product similarities of matching pairs including the product, a maximum product similarity as a to-be-processed similarity of the product; and determine a comprehensive product similarity between the first product provider and the second product provider. The comprehensive product similarity is determined based on a quantity of products whose to-be-processed similarities are greater than a specified threshold, a quantity of the products of the first product provider, and a quantity of the products of the second product provider. The judging unit may be configured to determine, based on the comprehensive product similarity, whether the first product provider is the same as the second product provider.

Duplication determination may be performed from a plurality of dimensions to improve accuracy. Therefore, in some embodiments, the apparatus may further include a second calculation module. The second calculation module may be configured to determine at least one attribute similarity between the first product provider and the second product provider based on at least one attribute factor of the first product provider and the second product provider.

In this case, the judging unit may be configured to determine, based on the comprehensive product similarity and the at least one attribute similarity, whether the first product provider is the same as the second product provider.

In some embodiments, the judging unit may be configured to: perform weighted summation of the comprehensive product similarity and the at least one attribute similarity to obtain a total similarity; and determine, based on the total similarity, whether the first product provider is the same as the second product provider.

The at least one attribute factor may include a provider name, a service address, a communication mode, and geographic coordinates.

In this embodiment of this disclosure, duplication determination may be performed from a plurality of dimensions and based on at least one attribute factor.

Therefore, determining reliability may be improved, thereby improving the accuracy and efficiency of duplication determination.

In some embodiments, the information determining apparatus in any one of the foregoing embodiments may be implemented as an electronic device, and the electronic device may be a server. As shown in FIG. 4, the electronic device may include one or more processors 401 and one or more memories 402.

The one or more memories 402 may store one or more computer instructions executable by the one or more processors 401. Upon being executed by the one or more processors 401, the computer instructions may cause the one or more processors 401 to perform the information determining method in any one of the foregoing method embodiments.

Additionally, this disclosure further provides a computer readable medium storing a computer program. Upon being executed by a computer, the computer program may cause the computer to perform the information determining method in any one of the foregoing method embodiments.

In a typical configuration, a computing device may include one or more processors (CPUs), an input/output interface, a network interface, and a memory.

The memory may include a non-persistent memory, a random access memory (RAM), a nonvolatile memory, and/or another form that are in a computer readable medium, for example, a read-only memory (ROM) or a flash memory (flash RAM). The memory is an example of the computer readable medium.

The computer readable medium may include persistent, non-persistent, movable, and unmovable media that can store information by using any method or technology. The information can be a computer readable instruction, a data structure, a program module, or other data. Examples of a computer storage medium include but are not limited to a parameter random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape storage or another magnetic storage device, or any other non-transmission medium that can be used to store information accessible by the computing device. Based on the definition in this specification, the computer readable medium does not include transitory computer readable media (transitory media) such as a modulated data signal and carrier.

For example, some words are used in the specification and claims to represent specific components. It should be understood by persons skilled in the art that a hardware manufacturer may name the same component by using different nouns. In the specification and claims, components are not distinguished between each other by using different names, and instead, the components are distinguished between each other by using different functions. For example, the word “inclusion” mentioned throughout the specification and claims is an open term and should be construed as “including but not limited to”. “Substantially” means an acceptable error range, and persons skilled in the art can resolve the technical problems within a specific error range to basically achieve the technical effects. In addition, the word “coupling” herein includes any direct/indirect electronic coupling means. Therefore, if the specification describes that a first apparatus is coupled to a second apparatus, it indicates that the first apparatus may be directly and electrically coupled to the second apparatus or indirectly and electrically coupled to the second apparatus by using another apparatus or another coupling means. The subsequent descriptions in the specification are example implementations of implementing this disclosure, and the descriptions are intended to describe general principles of this disclosure and are not intended to limit the scope of this disclosure. The protection scope of this disclosure shall be subject to that defined in the appended claims.

It should further be noted that the terms “include”, “comprise”, or any other variant thereof are intended to cover a non-exclusive inclusion, so that a commodity or a system that includes a list of elements not only includes those elements but also includes other elements that are not expressly listed, or further includes elements inherent to such a commodity or system. Without more constraints, an element preceded by “includes a . . . ” does not preclude the existence of additional identical elements in the commodity or system that includes the element.

The foregoing descriptions show and describe several example embodiments of this disclosure. However, as described above, it should be understood that this disclosure is not limited to the form disclosed in this specification, and should not be considered as an exclusion for other embodiments, but may be used for various other combinations, modifications, and environments, and can be modified within the scope of the application concept described in this specification by using the foregoing teaching or technologies or knowledge in the related field. All modifications and changes made by persons in the art without departing from the spirit and scope of this disclosure shall fall within the protection scope of the appended claims in this disclosure.

What is claimed is:

1. An information determining method, comprising:
determining a product similarity between a first product provider and a second product provider; and
determining, based on the product similarity, whether the first product provider is the same as the second product provider,
wherein determining a product similarity between a first product provider and a second product provider comprises:
obtaining at least one matching pair comprising a product of the first product provider and a product of the second product provider, wherein a price difference between the products meets a price deviation requirement; and
determining the product similarity between the products of the at least one matching pair.

2. The method of claim 1, further comprising: before determining the product similarity,
determining, based on a provider name of the first product provider, the second product provider matching the first product provider.

3. The method of claim 2, wherein determining the second product provider comprises:
obtaining backbone information from the provider name of the first product provider; and
determining the second product provider, wherein a provider name of the second product provider comprises the backbone information.

4. The method of claim 1, wherein determining whether the first product provider is the same as the second product provider comprises:
determining, based on the product similarity between the products of the at least one matching pair, whether the first product provider is the same as the second product provider.

5. The method of claim 4, wherein determining the product similarity between the products of the at least one matching pair comprises:
determining a string similarity between product names of the products in each of the at least one matching pair; and
designating the string similarity as the product similarity of each of the at least one matching pair.

6. The method of claim 4, wherein determining the product similarity between the products of the at least one matching pair comprises:
determining, based on picture information of the products in each of the at least one matching pair, an image similarity; and
designating the image similarity as the product similarity of each of the at least one matching pair.

7. The method of claim 4, wherein determining whether the first product provider is the same as the second product provider comprises:
for each of products of the first product provider and each of products of the second product provider, determining, among product similarities of matching pairs including the product, a maximum product similarity as a to-be-processed similarity of the product;
determining a comprehensive product similarity between the first product provider and the second product provider, wherein the comprehensive product similarity is a ratio of a quantity of the products whose to-be-processed similarities are greater than a specified threshold to a sum of a quantity of the products of the first product provider and a quantity of the products of the second product provider; and
determining, based on the comprehensive product similarity, whether the first product provider is the same as the second product provider.

8. The method of claim 7, further comprising:
determining, based on at least one attribute factor of the first product provider and the second product provider, at least one attribute similarity between the first product provider and the second product provider,
wherein determining whether the first product provider is the same as the second product provider comprises:
determining, based on the comprehensive product similarity and the at least one attribute similarity, whether the first product provider is the same as the second product provider.

9. The method of claim 8, wherein determining whether the first product provider is the same as the second product provider comprises:
determining, by performing weighted summation of the comprehensive product similarity and the at least one attribute similarity, a total similarity; and
determining, based on the total similarity, whether the first product provider is the same as the second product provider.

10. The method of claim 8, wherein the at least one attribute factor comprises a provider name, a service address, a communication mode, and geographic coordinates.

11. An information determining apparatus, comprising:
a first calculation module, configured to determine a product similarity between a first product provider and a second product provider; and
a judging module, configured to determine, based on the product similarity, whether the first product provider is the same as the second product provider,
wherein the first calculation module comprises:
a matching unit, configured to obtain at least one matching pair comprising a product of the first product provider and a product of the second product provider, wherein a price difference between the products meets a price deviation requirement; and
a first calculation unit, configured to determine the product similarity between the products of the at least one matching pair.

12. The apparatus of claim 11, further comprising:
a determining module, configured to determine, based on a provider name of the first product provider, the second product provider matching the first product provider.

13. The apparatus of claim 12, wherein the determining module comprises:
a selection unit, configured to obtain backbone information from the provider name of the first product provider; and
a determining unit, configured to determine the second product provider, wherein a provider name of the second product provider comprises the backbone information.

14. The apparatus according to claim 11, wherein the judging module is configured to determine, based on the product similarity between the products of the at least one matching pair, whether the first product provider is the same as the second product provider.

15. The apparatus of claim 14, wherein the first calculation unit is configured to:
determine a string similarity between product names of the products in each of the at least one matching pair; and
designate the string similarity as the product similarity of each of the at least one matching pair.

16. The apparatus of claim 14, wherein the first calculation unit is configured to:
determine, based on picture information of the products in each of the at least one matching pair, an image similarity; and
designate the image similarity as the product similarity of each of the at least one matching pair.

17. The apparatus of claim 14, wherein the judging module comprises:
a second calculation unit, configured to:
for each of products of the first product provider and each of products of the second product provider, determine, among product similarities of matching pairs including the product, a maximum product similarity as a to-be-processed similarity of the product; and
determine a comprehensive product similarity between the first product provider and the second product provider, wherein the comprehensive product similarity is a ratio of a quantity of products whose to-be-processed similarities are greater than a specified threshold to a sum of a quantity of the products of the first product provider and a quantity of the products of the second product provider; and
a judging unit, configured to determine, based on the comprehensive product similarity, whether the first product provider is the same as the second product provider.

18. The apparatus of claim 17, further comprising:
a second calculation module, configured to determine, based on at least one attribute factor of the first product provider and the second product provider, at least one attribute similarity between the first product provider and the second product provider,
wherein the judging unit is configured to determine, based on the comprehensive product similarity and the at least one attribute similarity, whether the first product provider is the same as the second product provider.

19. The apparatus of claim 18, wherein the judging unit is configured to:
determine, by performing weighted summation of the comprehensive product similarity and the at least one attribute similarity, a total similarity; and
determine, based on the total similarity, whether the first product provider is the same as the second product provider.

20. The apparatus of claim 18, wherein the at least one attribute factor comprises a provider name, a service address, a communication mode, and geographic coordinates.

21. An electronic device, comprising one or more processors and one or more memories, wherein the one or more memories store one or more computer instructions executable by the one or more processors,
and wherein upon being executed by the one or more processors, the one or more computer instructions cause the one or more processors to perform an information determining method, comprising:
determining a product similarity between a first product provider and a second product provider; and
determining, based on the product similarity, whether the first product provider is the same as the second product provider,
wherein determining a product similarity between a first product provider and a second product provider comprises:
obtaining at least one matching pair comprising a product of the first product provider and a product of the second product provider, wherein a price difference between the products meets a price deviation requirement; and
determining the product similarity between the products of the at least one matching pair.

22. A computer readable storage medium storing a computer program, wherein upon being executed by a computer, the computer program causes the computer to perform the information determining method of claim 1.
